(19) United States
(12) Patent Application Publication
(10) Pub. No.: US 2020/0038807 A1
(43) Pub. Date: Feb. 6, 2020

(54) METHOD AND APPARATUS FOR FIXING CARBON DIOXIDE, AND FUEL GAS DESULFURIZATION FACILITY

(71) Applicant: IHI Corporation, Koto-ku (JP)

(72) Inventors: Toshiyuki NAITO, Koto-ku (JP); Hidekazu KASAI, Koto-ku (JP)

(73) Assignee: IHI Corporation, Koto-ku (JP)

(21) Appl. No.: 16/600,683

(22) Filed: Oct. 14, 2019

Related U.S. Application Data
(63) Continuation of application No. PCT/JP2018/025439, filed on Jul. 5, 2018.

(30) Foreign Application Priority Data
Aug. 8, 2017 (JP) 2017-152924

(51) Int. Cl. B01D 53/62; B01D 53/50; B01D 53/78

(52) U.S. Cl. CPC B01D 53/62; B01D 53/504; B01D 53/502; B01D 53/78; B01D 2252/1035; B01D 2257/302; B01D 2257/504; B01D 2251/402; B01D 2251/404; B01D 2251/302; B01D 2251/304; B01D 2251/306; B01D 2258/0283

(57) ABSTRACT

Provided are an absorbing column in which flue gas containing sulfur oxides is desulfurized by seawater and a reactor vessel in which alkali earth metal or alkali metal is added to the seawater having absorbed the sulfur oxides from the flue gas in the absorbing column to produce a compound which is stable like minerals.

### TECHNICAL FIELD

The present disclosure relates to a method and an apparatus for fixing carbon dioxide and a flue gas desulfurization facility.

### BACKGROUND ART

Sulfur oxides (SO₂ and the like) in flue gas discharged from, for example, a coal-fired boiler in a thermal power plant is generally absorbed and removed by a flue gas desulfurization facility.

In some of the flue gas desulfurization facilities, seawater is used as an absorbing liquid to desulfurize the flue gas.

A reference showing general state of the art pertain to the flue gas desulfurization facility is, for example, Patent Literature 1.

### CITATION LIST

### Patent Literature

Patent Literature 1: JPH 09-239233A

### SUMMARY

### Technical Problems

Conventionally, carbon dioxide (CO₂) in flue gas from a flue gas desulfurization facility has been discharged with no change and no specific consideration. Nowadays, reduction of carbon dioxide to be discharged becomes an urgent issue so that demand for carbon dioxide fixation techniques increases and the techniques have been developed to recover carbon dioxide through a chemical absorption or oxyfuel combustion process and store the same as supercritical carbon dioxide in an underground water-bearing layer.

However, since the carbon dioxide stored in the underground water-bearing layer is a liquid, it is unknown whether the carbon dioxide can be stably sealed deep in the earth for a long period of time. It is not utterly impossible that the carbon dioxide may leak out on earth due to an earthquake and the like so that monitoring for a long period of time is required. Besides, there exist plenty of presently unsolved issues such as whether injection of the liquid carbon dioxide deep in the earth under a high pressure may cause an earthquake to happen.

Thus, in view of the above, the disclosure explains a method and an apparatus for fixing carbon dioxide and a flue gas desulfurization facility which can stably fix carbon dioxide without storing the same in an underground water-bearing layer.

### Solution to Problems

A method for fixing carbon dioxide according to the disclosure comprises

a seawater desulfurization step of desulfurizing flue gas containing sulfur oxides by seawater and

an addition step of adding an element selected from a group consisting of alkali earth metal and alkali metal to the seawater having absorbed the sulfur oxides from the flue gas in said seawater desulfurization step to produce a compound.

The method for fixing carbon dioxide may further comprise a recovery step of recovering the compound produced in said addition step.

In the method for fixing carbon dioxide, said alkali earth metal may be an element selected from a group consisting of calcium and magnesium.

In the method for fixing carbon dioxide, said alkali metal may be an element selected from a group consisting of lithium, sodium and potassium.

Meanwhile, an apparatus for fixing carbon dioxide according to the disclosure comprises

an absorbing column in which flue gas containing sulfur oxides is desulfurized by seawater and

a reaction vessel in which an element selected from a group consisting of alkali earth metal and alkali metal is added to the seawater having absorbed the sulfur oxides from the flue gas in said absorbing column to produce a compound.

The apparatus for fixing carbon dioxide may further comprise a recovery unit for recovery of the compound produced in said reaction vessel.

In the apparatus for fixing carbon dioxide, said alkali earth metal may be an element selected from a group consisting of calcium and magnesium.

In the apparatus for fixing carbon dioxide, said alkali metal may be an element selected from a group consisting of lithium, sodium and potassium.

Further, a flue gas desulfurization facility may be provided which has said apparatus for fixing carbon dioxide.

### Effects

A method and an apparatus for fixing carbon dioxide and a flue gas desulfurization facility according to the invention can exhibit an excellent effect that the carbon dioxide can be stably fixed without storing the same in an underground water-bearing layer.

### BRIEF DESCRIPTION OF DRAWING

FIG. 1 is a schematic overall diagram showing an embodiment of a method and an apparatus for fixing carbon dioxide and a flue gas desulfurization facility according to the disclosure; and

FIG. 2 is a flowchart showing steps in the disclosed embodiment of the method for fixing carbon dioxide.

### DESCRIPTION OF EMBODIMENT

An embodiment of the invention in the disclosure will be described in conjunction with the attached drawing.

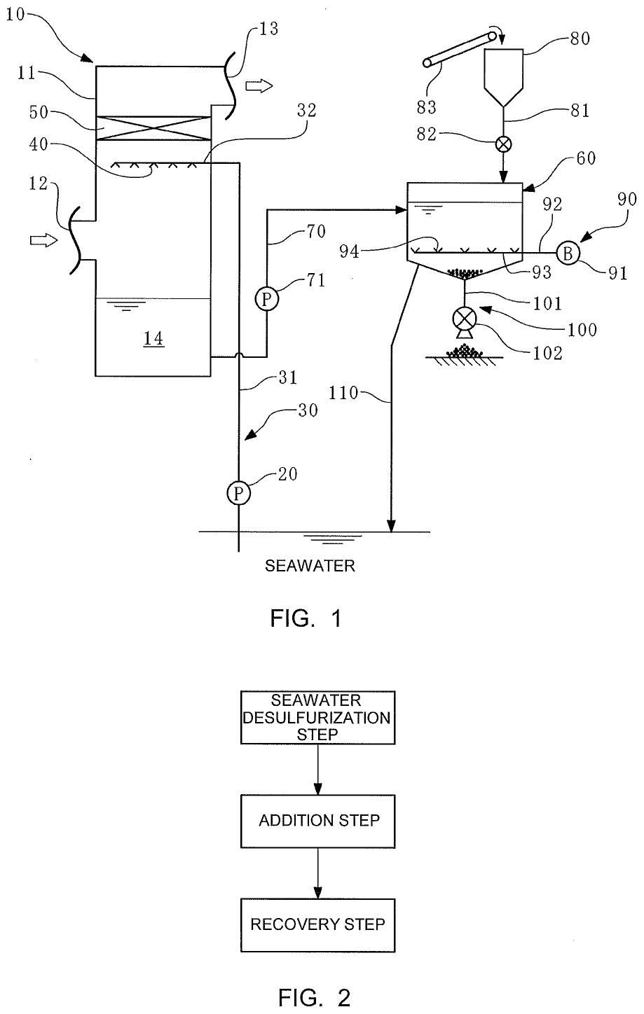

FIGS. 1 and 2 show the embodiment of a method and an apparatus for fixing carbon dioxide and a flue gas desulfurization facility of the disclosure.

The flue gas desulfurization facility shown in FIG. 1 comprises an absorbing column 10, a seawater pump 20, a seawater line 30 and spray nozzles 40.

The absorbing column 10 comprises a vertically extending column body 11 with a side surface and an upper portion on which inlet and outlet ports 12 and 13 are formed for flue gas, respectively. An inside of the column body 11 below the inlet port 12 provides a reservoir 14 for seawater as an absorbing liquid.

The seawater pump 20 is a pump which pumps up from sea the seawater as the absorbing liquid.

The seawater line 30 has one end under the sea, stands upward and has the other end extending through the side surface of the column body 11 into inside thereof. The seawater pump 20 is incorporated in the seawater line 30 to feed the seawater as the absorbing liquid pumped by the seawater pump 20 through the seawater line 30 to the absorbing column 10. The seawater line 30 shown in FIG. 1 comprises a pumping-up line 31 with one end in the sea and standing upward and a spray header 32 connected to the other end of the pumping-up line 31 and extending inside of the column body 11. Alternatively, the pumping-up line 31 may have the one end not in the sea but in a seawater vessel (not shown) for store of the seawater.

The spray nozzles 40 are connected to and arranged on the seawater line 30 extending inside of the column body 11 in a longitudinally spaced-apart relationship to inject the seawater as the absorbing liquid inside of the absorbing column 10. The spray nozzles 40 shown in FIG. 1 are arranged on the spray header 32 of the seawater line 30.

Arranged inside of the absorbing column 10 above the spray nozzles 40 is a mist eliminator 50 for removal of mist from the flue gas.

The flue gas desulfurization facility shown in FIG. 1 has a reaction vessel 60 as an apparatus for fixing the carbon dioxide.

The reaction vessel 60 serves to add an element selected from a group consisting of alkali earth metal and alkali metal to the seawater having absorbed the sulfur oxides from the flue gas in the absorbing column 10 to produce a compound which is stable just like minerals. The reaction vessel 60 is connected to the reservoir 14 of the absorbing column 10 through an extracting line 70 in which an extracting pump 71 is incorporated. By an operation of the extracting pump 71, the seawater is guided from the reservoir 14 through the extracting line 70 to the reaction vessel 60.

Arranged above the reaction vessel 60 is a hopper 80 in which the element selected from the group consisting of alkali earth metal and alkali metal is stored. The element selected from the group consisting of alkali earth metal and alkali metal stored in the hopper 80 is fed by a feed line 81 through a rotary feeder or other feed valve 82 to the reaction vessel 60. The hopper 80 is fed with a supplementary element selected from the group consisting of alkali earth metal and alkali metal from a feed source (not shown) by a conveyor 83.

Arranged on a lower portion of the reaction vessel 60 is an oxidizing agent feeder 90 comprising an oxidative air blower 91 which feeds air as an oxidizing agent to the reaction vessel 60. Connected to a discharge side of the oxidative air blower 91 of the oxidizing agent feeder 90 shown in FIG. 1 is an oxidizing agent feed line 92 which guides the air as the oxidizing agent to the reaction vessel 60. The oxidizing agent feed line 92 has a header 93 extending into the reaction vessel 60 and having aerating nozzles 94 thereon in a longitudinally spaced-apart relationship so as to inject air as an oxidizing agent through the aerating nozzles 94 into the reaction vessel 60 for uniform admixture of the air into the seawater.

The apparatus for fixing carbon dioxide shown in FIG. 1 has a recovery unit 100 for recovery of the compound produced in the reaction vessel 60. The recovery unit 100 comprises a recovery line 101 for extraction of the compound accumulated on a bottom of the reaction vessel 60 and a recovery valve 102 incorporated in the recovery line 101. The recovery unit 100 may further comprise a solid-liquid separator (not shown) downstream of the recovery valve 102 as needs demand. Connected to the lower portion of the reaction vessel 60 is a return line 110 which servers to return the seawater to the sea. However, when the compound produced in the reaction vessel 60 is harmless, the recovery unit 100 is not necessarily a requisite; the compound may be returned together with the seawater to the sea.

Calcium (Ca) or magnesium (Mg) may be selected as the alkali earth metal. Waste concrete, iron and steel slag, andesite, basalt, soil or fry ash may be listed up as a material containing an element selected from a group consisting of calcium and magnesium. Magnesium is a group 2 element but, in a narrow sense, is not alkali earth metal due to difference in chemical nature; however, it may be regarded as alkali earth metal in a broad sense.

Lithium (Li), sodium (Na) or potassium (K) may be selected as the alkali metal. Igneous rock or granite may be listed up as a material containing an element selected from a group consisting of lithium, sodium and potassium.

FIG. 2 is a flowchart showing steps in the embodiment of the method for fixing carbon dioxide according to the disclosure which are a seawater desulfurization step, an addition step and a recovery step.

The seawater desulfurization step is a step of desulfurizing the flue gas containing the sulfur oxides by the seawater.

The addition step is a step of adding the element selected from the group consisting of alkali earth metal and alkali metal to the seawater having absorbed the sulfur oxides from the flue gas in the seawater desulfurization step to produce a compound which is stable like minerals.

The recovery step is a step of recovering the compound produced in the addition step. However, as mentioned above, when the compound produced in the reaction vessel 60 is harmless, the recovery unit 100 is not necessarily a requisite and the compound may be returned together with the seawater to the sea. Thus, the method for fixing carbon dioxide may omit the recovery step and comprise only the seawater desulfurization and addition steps.

Next, mode of operation of the above embodiment will be described.

In a normal operation of the absorbing column 10, the seawater pump 20 is driven to make the seawater to flow through the seawater line 30; then, the seawater is injected by the spray nozzles 40 into inside of the absorbing column 10 and flows down to the reservoir 14. The flue gas fed from the coal-fired boiler or the like (not shown) to the absorbing column 10 makes gas-liquid contact with the seawater as the absorbing liquid injected through the spray nozzles 40 to make the sulfur oxides to be absorbed and removed from the flue gas from which the mist is then removed by the mist eliminator 50; ultimately, the glue gas is allowed to discharge through the outlet port 13 of the absorbing column 10 to outside. This is the seawater desulfurization step in FIG. 2. Absorption reactions in this case are as follows:

SO₂+H₂O→HSO₃⁻+H⁺

CO₂+H₂O→HCO₃⁻+H⁺

HCO₃⁻→CO₃²⁻+H⁺

By the operation of the extracting pump 71, the seawater in the reservoir 14 is guided through the extracting line 70 to the reaction vessel 60. Concurrently, air as an oxidizing agent is fed by the oxidative air blower 91 of the oxidizing agent feeder 90 through the oxidizing agent feed line 92 to the aerating nozzles 94 from which the air as the oxidizing agent is injected into the reaction vessel 60 and uniformly admixed into the seawater. An oxidization reaction in this case is as follows:

HSO₃⁻+1/2O₂→SO₄²⁻+H⁺

Then, the element selected from the group consisting of alkali earth metal and alkali metal stored in the hopper 80 is fed from the feed line 81 through the rotary feeder or other feed valve 82 to the reaction vessel 60. This is an addition step in FIG. 2. When calcium (Ca) or magnesium (Mg) is selected as the alkali earth metal and waste concrete, iron and steel slag, andesite, basalt, soil or fry ash is fed to the reaction vessel 60, reactions in this case are as follows:

Ca²⁺+CO₃²⁻→CaCO₃

Mg²⁺+CO₃²⁻→MgCO₃

When lithium (Li), sodium (Na) or potassium (K) is selected as the alkali metal and igneous rock or granite is fed to the reaction vessel 60, reactions in this case are as follows:

2Li⁺+CO₃²⁻→Li₂CO₃

2Na⁺+CO₃²→Na₂CO₃

2K⁺+CO₃²⁻→K₂CO₃

The compound produced in the reaction vessel 60 is recovered through the recovery line 101 by opening the recovery valve 102 in the recovery unit 100. This is a recovery step in FIG. 2.

The seawater in the reaction vessel 60 is returned through the return line 110 to the sea.

As mentioned above, the desulfurized seawater contains HCO₃ ion in which the carbon dioxide is dissolved; according to the embodiment, an element selected from the group consisting of alkali earth metal and alkali metal is fed thereto to fix the carbon dioxide as the compound which is stable as minerals. Specifically, unlike the conventional storing of liquid carbon dioxide in an underground water-bearing layer, in the embodiment, the carbon dioxide can be sealed as the compound stable like minerals for a long period of time so that there is no possibility of the carbon dioxide leaking out on earth due to an earthquake and the like and no monitoring for a long period of time is required. The liquid carbon dioxide is not injected under a high pressure in the earth so that there is no possibility of an earthquake being caused.

Thus, in the method and the apparatus for fixing carbon dioxide according to the embodiment, carbon dioxide can be stably fixed without storing the same in an underground water-bearing layer.

And in the method for fixing carbon dioxide according to the embodiment, the recovery step is conducted to recover the compound produced in the addition step. Due to such recovery step conducted, the compound is not returned to the sea, which contributes to prevent influences on marine organisms and environment. In the apparatus for fixing carbon dioxide according to the embodiment, provided is the recovery unit 100 which recovers the compound produced in the reaction vessel 60. Such provision of the recovery unit 100 makes the compound to be recovered by the recovery unit 100 without being returned to the sea, which contributes to prevent influences on marine organisms and environment.

In the method and the apparatus for fixing carbon dioxide according to the embodiment, the alkali earth metal used is the element selected from the group consisting of calcium and magnesium which may be contained, for example, in waste concrete, iron and steel slag, andesite, basalt, soil or fry ash so that waste materials may be effectively utilized for fixation of the carbon dioxide while being disposed. Moreover, when calcium is used, calcium carbonate (CaCO₃) produced as the compound is a main component of a skeleton of shells and coral and exists in the sea so that there is no problem caused even if the compound is returned as it is to the sea. When magnesium is used, magnesium carbonate (MgCO₃) produced as the compound is utilizable as an augmenting agent for natural or synthetic rubber, fire-resistant and insulator material, raw material for dung and addition agent for ink, paint, glass, papermaking, cosmetics and food.

In the method and the apparatus for fixing carbon dioxide according to the embodiment, when the alkali metal used is the element selected from the group consisting of lithium, sodium and potassium contained, for example, in igneous rock or granite, lithium carbonate (Li₂CO₃), sodium carbonate (Na₂CO₃) or potassium carbonate (K₂CO₃) produced as the compound is utilizable as the industrially important compound.

Also in a flue gas desulfurization facility with the apparatus for fixing carbon dioxide according to the embodiment, the carbon dioxide can be stably fixed without storing the same in an underground water-bearing layer.

It is to be understood that a method and an apparatus for fixing carbon dioxide and a flue gas desulfurization facility according to the invention are not limited to the above embodiment and that various changes and modifications may be made without departing from the scope of the invention.

### REFERENCE SIGNS LIST

10 absorbing column
60 reaction vessel
100 recovery unit

1. A method for fixing carbon dioxide comprising
a seawater desulfurizing step of desulfurizing flue gas containing sulfur oxides by seawater and
an addition step of adding an element selected from a group consisting of alkali earth metal and alkali metal to the seawater having absorbed the sulfur oxides from the flue gas in said seawater desulfurizing step to produce a compound.

2. The method for fixing carbon dioxide as claimed in claim 1, further comprising a recovery step of recovering the compound produced by said addition step.

3. The method for fixing carbon dioxide as claimed in claim 1, wherein said alkali earth metal is an element selected from a group consisting of calcium and magnesium.

4. The method for fixing carbon dioxide as claimed in claim 2, wherein said alkali earth metal is an element selected from a group consisting of calcium and magnesium.

5. The method for fixing carbon dioxide as claimed in claim 1, wherein said alkali metal is an element selected from a group consisting of lithium, sodium and potassium.

6. The method for fixing carbon dioxide as claimed in claim 2, wherein said alkali metal is an element selected from a group consisting of lithium, sodium and potassium.

7. An apparatus for fixing carbon dioxide comprising
an absorbing column in which flue gas containing sulfur oxides is desulfurized by seawater and
a reactor vessel in which an element selected from a group consisting of alkali earth metal and alkali metal is added to the seawater having absorbed the sulfur oxides from the flue gas in said absorbing column to produce a compound.

8. The apparatus for fixing carbon dioxide as claimed in claim 7 further comprising a recovery unit for recover of the compound produced in said reaction vessel.

9. The apparatus for fixing carbon dioxide as claimed in claim 7, wherein said alkali earth metal is an element selected from a group consisting of calcium and magnesium.

10. The apparatus for fixing carbon dioxide as claimed in claim 8, wherein said alkali earth metal is an element selected from a group consisting of calcium and magnesium.

11. The apparatus for fixing carbon dioxide as claimed in claim 7, wherein said alkali metal is an element selected from a group consisting of lithium, sodium and potassium.

12. The apparatus for fixing carbon dioxide as claimed in claim 8, wherein said alkali metal is an element selected from a group consisting of lithium, sodium and potassium.

13. A flue gas desulfurization facility with said apparatus for fixing carbon dioxide as claimed in claim 7.

14. A flue gas desulfurization facility with said apparatus for fixing carbon dioxide as claimed in claim 8.

15. A flue gas desulfurization facility with said apparatus for fixing carbon dioxide as claimed in claim 9.

16. A flue gas desulfurization facility with said apparatus for fixing carbon dioxide as claimed in claim 10.

17. A flue gas desulfurization facility with said apparatus for fixing carbon dioxide as claimed in claim 11.

18. A flue gas desulfurization facility with said apparatus for fixing carbon dioxide as claimed in claim 12.
